(19) United States
(12) Patent Application Publication
(10) Pub. No.: US 2016/0100921 A1
(43) Pub. Date: Apr. 14, 2016

(54) DENTAL CLEANING APPARATUS

(71) Applicant: Dale Ungar, Weston, FL (US)

(72) Inventor: Dale Ungar, Weston, FL (US)

(21) Appl. No.: 14/881,612

(22) Filed: Oct. 13, 2015

Related U.S. Application Data
(60) Provisional application No. 62/063,511, filed on Oct. 14, 2014.

(51) Int. Cl. A61C 17/02

(52) U.S. Cl. CPC A61C 17/02; A61C 17/0205

(57) ABSTRACT

A dental cleaning apparatus is configured as a hand-held unit. The appliance includes a housing body having an interior housing cavity. The housing cavity includes an upper compartment configured to receive a volume of cleaning composition within or in absence of a container. The container may be permanently fixed in the interior housing cavity of the housing body or may be removable and replaceable through an uncoverable side opening in the housing body The housing cavity also includes a lower compartment configured to receive a pressurized air canister. An elongated hollow nozzle assembly is mounted to an upper end section of the housing body and has a nozzle conduit providing fluid communication between the cleaning composition and a tip section of the hollow nozzle assembly.

### CROSS REFERENCE(S) TO RELATED APPLICATION(S)

This U.S. non-provisional patent application claims the benefit of co-pending U.S. provisional patent application No. 62/063,511, filed Oct. 14, 2014, which is incorporated by reference herein in its entirety.

### FIELD OF THE INVENTION

The present invention relates to dental cleaning devices. More particularly, the invention pertains to portable handheld apparatus adapted to discharge a contained pressurized stream of an abrasive composition for cleaning an exterior surface of teeth.

### BACKGROUND OF THE INVENTION

A variety of dental devices are known for cleaning, polishing and otherwise treating an exterior surface of a tooth. For example, air polishing is a procedure that uses air and water pressure to deliver a controlled stream of specially processed sodium bicarbonate or glycine powders in the form of slurry through a device nozzle. Fine particles of powders are propelled by compressed air in a warm spray and directed onto the surface of the teeth. This pressurized jet of air, water and powder removes surface stains, plaque and other soft deposits such as food particles trapped between teeth. Conventionally, such devices are expensive and available to dental professionals such as dentists and dental hygienists. For example, one such device sold under the trade name AIR-FLOW, utilizes an air-powder mixture and water for a variety of preventative and restorative dental treatments. This commercially-available product involves projecting a jet of compressed air, water and fine powder particles onto the surface of the tooth to polish the surface and remove debris. However, this apparatus is complex, expensive and relies upon the use of an external pressurization source as well as an external abrasive powder and water source.

Such devices for home use are less available, primarily due to their complexity and high cost. Again, in a typical arrangement a fluidized stream of high-energy particles is delivered to a dental site, such as one or more teeth in the mouth of an individual, or a surface of a removable dental appliance. The power for activating and developing a jet stream of particle emissions is typically provided by an external source of pressurized air or liquid, such as water, requiring an assembly of parts to provide the appropriate coupling, in addition to a tank of pressurized air, water and the like. The need for technical expertise and external power sources limits the use of such dental appliances outside of a professional dental environment, such as in a home environment. Moreover, conventional dental appliances are very expensive, and lack sufficient storage capacity to contain an adequate volume of an abrasive composition, such as dry powder, to perform a complete cleaning procedure or to prepare a tooth surface during a dental restoration process. To overcome this deficiency, hook-ups are needed to transmit powder from an external source. Again, this requirement hinders home use applications.

Accordingly, there remains an unmet need in the art for such a dental cleaning apparatus that is portable, easy to use, and relatively inexpensive, which can be used by a non-professional dental consumer to effectively clean, polish or otherwise treat the exterior surface of a human or animal tooth, a dental appliance and the like.

### SUMMARY OF THE INVENTION

The present invention overcomes the drawbacks, limitations and disadvantages of the known art providing a pressurized dental cleaning apparatus, which, in one implementation incorporates disposable pressurized air cartridges and disposable abrasive cleaning composition containment cartridges. In an alternate implementation, the device can incorporate a refillable permanent abrasive cleaning composition holding chamber or reservoir.

In accordance with an aspect of the present invention, a portable handheld pressurized dental cleaning apparatus includes:
a housing body defining an interior cavity having an upper compartment and a lower compartment;
an elongated hollow nozzle assembly mounted to the housing body and having a proximal end and a distal end, the proximal end being disposed in fluid communication with the upper compartment of the housing body interior cavity, the distal end terminating outside of the housing body;
a volume of cleaning composition contained within the upper compartment of the housing body interior cavity, the proximal end of said hollow nozzle assembly being in fluid communication with the cleaning composition;
a self-contained pressurized air cartridge disposed within the lower compartment of the housing body interior cavity; and
an actuator mechanism connecting the pressurized air cartridge in the lower compartment of the housing body interior cavity to the cleaning composition in the upper compartment of the housing body interior cavity, the actuator mechanism being selectively activated at an exterior location on the housing body to controllably actuate and enable fluid communication of pressurized air from the pressurized air cartridge to the volume of cleaning composition in the upper compartment of the housing body interior cavity so as to thereby cause pressurized flow of portions of the cleaning composition into the proximal end of the hollow nozzle assembly and from the distal end of the hollow nozzle assembly.

In another aspect of the present invention, the hollow nozzle assembly has an elongated hollow nozzle conduit extending between an inlet aperture at the proximal end and an outlet aperture at the distal end, the proximal end inlet aperture being contained within the upper compartment of the housing body interior cavity in fluid communication with the volume of cleaning composition, the distal end outlet aperture being disposed outside of the housing body.

In another aspect of the present invention, the apparatus also includes a reservoir disposed within the upper compartment of the housing body interior cavity and being configured for holding the volume of cleaning composition, the proximal end of the hollow nozzle assembly being in fluid communication with the reservoir. The housing body has an angled partition wall dividing the interior cavity into the lower compartment and the reservoir of the upper compartment.

In another aspect of the present invention, the housing body has a bottom opening in a lower end of the housing body for gaining access to the lower compartment of the housing body interior cavity. The pressurized air cartridge is insertable into and removable from the lower compartment through the bottom opening in the lower end of the housing body.

In another aspect of the present invention, a portable handheld pressurized dental cleaning apparatus includes:
a housing body defining an interior cavity having an upper compartment and a lower compartment;
an elongated hollow nozzle assembly mounted to the housing body and having a proximal end and a distal end, the hollow nozzle assembly having an elongated hollow nozzle conduit extending between an inlet aperture at the proximal end of the hollow nozzle assembly and an outlet aperture at the distal end of the hollow nozzle assembly, the proximal end inlet aperture being disposed in fluid communication with the upper compartment of the housing body interior cavity, the distal end outlet aperture being disposed outside of the housing body;
a container disposed within the upper compartment of the housing body interior cavity and being configured for holding a volume of cleaning composition, the proximal end inlet aperture of the hollow nozzle assembly being in fluid communication with the volume of cleaning composition in the container;
a self-contained pressurized air cartridge provided within the lower compartment of the housing body interior cavity; and
an actuator mechanism connecting the pressurized air cartridge in the lower compartment of the housing body interior cavity to the container in the upper compartment of the housing body interior cavity, the actuator mechanism being selectively activated at an exterior location on the housing body to controllably actuate and enable fluid communication of pressurized air from the pressurized air cartridge in the lower compartment to the volume of cleaning composition in the container in the upper compartment so as to thereby cause pressurized flow of portions of the cleaning composition into the proximate end inlet aperture of the hollow nozzle assembly and from the distal end outlet aperture of the hollow nozzle assembly.

In another aspect of the present invention, the container is a capsule fixedly and permanently disposed within the upper compartment of the housing body interior cavity and being configured for holding the volume of cleaning composition. The proximal end inlet aperture of the hollow nozzle assembly is disposed in fluid communication with the cleaning composition in the capsule.

In another aspect of the present invention, the container is a canister removably disposed within the upper compartment of the housing body interior cavity and being configured for holding the volume of cleaning composition. The proximal end inlet aperture of the hollow nozzle assembly is disposed in fluid communication with the cleaning composition in the canister.

In another aspect of the present invention, the housing body has a removable cover detachably attached over a side opening in the housing body for gaining access to the upper compartment of the housing body interior cavity. The cleaning composition canister is insertable into and removable from the upper compartment through the side opening in the housing body.

In another aspect of the present invention, the housing body also has a bottom opening in a lower end of the housing body for gaining access to the lower compartment of the housing body interior cavity. The pressurized air cartridge is insertable into and removable from the lower compartment through the bottom opening in the lower end of the housing body.

In another aspect of the present invention, a portable handheld pressurized dental cleaning apparatus includes:
a housing body having an upper shell portion and a lower receptacle portion detachably attached to the upper shell portion and together defining an interior cavity, the upper shell defining an upper compartment of the housing body interior cavity, the lower receptacle portion defining a lower compartment of the housing body interior cavity;
an elongated hollow nozzle assembly mounted to the upper shell portion of the housing body and having a proximal end and a distal end, the hollow nozzle assembly having an elongated hollow nozzle conduit extending between an inlet aperture at the proximal end of the hollow nozzle assembly and an outlet aperture at the distal end of the hollow nozzle assembly, the proximal end inlet aperture of the hollow nozzle assembly being disposed in fluid communication with the upper compartment of the housing body interior cavity, the distal end outlet aperture of the hollow nozzle assembly being disposed outside of the housing body;
a container disposed within the upper compartment in the upper shell portion of the housing body and being configured for holding a volume of cleaning composition, the proximal end inlet aperture of the hollow nozzle assembly being in fluid communication with the volume of cleaning composition in the container;
a self-contained pressurized air cartridge provided within the lower compartment in the lower receptacle portion of the housing body; and
an actuator mechanism connecting the pressurized air cartridge in the lower compartment to the cleaning composition container in the upper compartment, the actuator mechanism including a pressure regulator and a release valve, the pressure regulator supported at and extending below a lower end of the upper shell portion and in fluid communication with the pressurized air cartridge, the release valve being supported by the upper shell portion and disposed between the pressure regulator and the container such that the release valve is connected in fluid communication with the pressure regulator and the cleaning composition container and is selectively activated at an exterior location on the housing body adjacent to the upper shell portion to controllably actuate and enable fluid communication of pressurized air from the pressurized air cartridge in the lower compartment to the volume of cleaning composition in the cleaning composition container in the upper compartment so as to thereby cause pressurized flow of portions of the cleaning composition into the proximal end inlet aperture of the hollow nozzle assembly and from the distal end outlet aperture of the hollow nozzle assembly.

In another aspect of the present invention, the upper shell portion of the housing body includes left and right sections with sets of complementary protrusions thereon being connectable with one another so as to securely fit the left and right sections together and thereby form the upper shell portion and enclose and support the hollow nozzle assembly at the proximate end thereof, the cleaning composition container, and the pressure regulator and release valve of the actuator mechanism.

In another aspect of the present invention, the upper shell portion of the housing body has a removable cover detachably attached over a side opening in the upper shell portion for gaining access to the upper compartment of the housing body, the cleaning composition container being insertable into and removable from the upper compartment through the side opening in the housing body.

In another aspect of the present invention, the lower receptacle portion of the housing body has a top opening in an upper end of the lower receptacle portion for gaining access to the lower compartment of the housing body, the pressurized air cartridge being insertable into and removable from the lower compartment through the top opening in the upper end of the lower receptacle portion of the housing body.

In another aspect of the present invention, the dental cleaning apparatus is adaptable for both professional and home usage.

In another aspect of the present invention, the dental cleaning apparatus is adaptable for non-dental applications as well, including, for example, removing a material disposed upon a surface of a metal, ceramic or polymer object.

In another aspect of the present invention, the dental cleaning apparatus functions to improve oral health.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents an isometric view of a portable handheld pressurized dental cleaning apparatus in accordance with an exemplary implementation of the present invention, incorporating a selectively removable pressurized air canister and a fixedly and permanently mounted cleaning composition containment capsule;

FIG. 2 presents an isometric view of the pressurized dental cleaning apparatus of FIG. 1, illustrating the incorporation of a bottom-loaded pressurized air canister;

FIG. 3 presents a cross-sectional view of the pressurized dental cleaning apparatus of FIG. 1, taken along section lines 3-3 of FIG. 1;

FIG. 4 presents an isometric view of a fully-assembled pressurized dental cleaning apparatus in accordance with a further exemplary implementation, illustrating a side-loadable cleaning composition containment cartridge;

FIG. 5 presents an isometric view of the pressurized dental cleaning apparatus of FIG. 4, illustrating the side loading cleaning composition containment cartridge and respective housing body side opening and removable cover shown in a partially-exploded view;

FIG. 6 presents a cross-sectional view of the pressurized dental cleaning apparatus of FIG. 4, taken along section lines 6-6 of FIG. 4;

FIG. 7 presents an isometric view of a pressurized dental cleaning apparatus in accordance with another exemplary implementation of the present invention, wherein a cleaning composition containment reservoir is integrated directly into the interior cavity of the apparatus housing body;

FIG. 8 presents a cross-sectional view of the pressurized dental cleaning apparatus of FIG. 7, taken along section lines 8-8 of FIG. 7;

FIG. 9 presents an isometric view of a fully-assembled pressurized dental cleaning apparatus in accordance with yet another exemplary implementation of the present invention;

FIG. 10 presents a front isometric exploded view of the pressurized dental cleaning apparatus of FIG. 9, illustrating a plurality of components that interfit together to provide an apparatus housing in which are mounted in a cooperative relationship a pressurized air canister, a pressure valve, a release valve and a cleaning composition containment cartridge;

FIG. 11 presents a rear isometric exploded view of the pressurized dental cleaning apparatus of FIG. 9, illustrating the same plurality of components as shown in FIG. 10 but from a different angle of view; and

FIG. 12 presents a cross-sectional view of the pressurized dental cleaning apparatus of FIG. 9, taken along section lines 12-12 of FIG. 9.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall be used to describe the invention in accordance with their common meaning. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

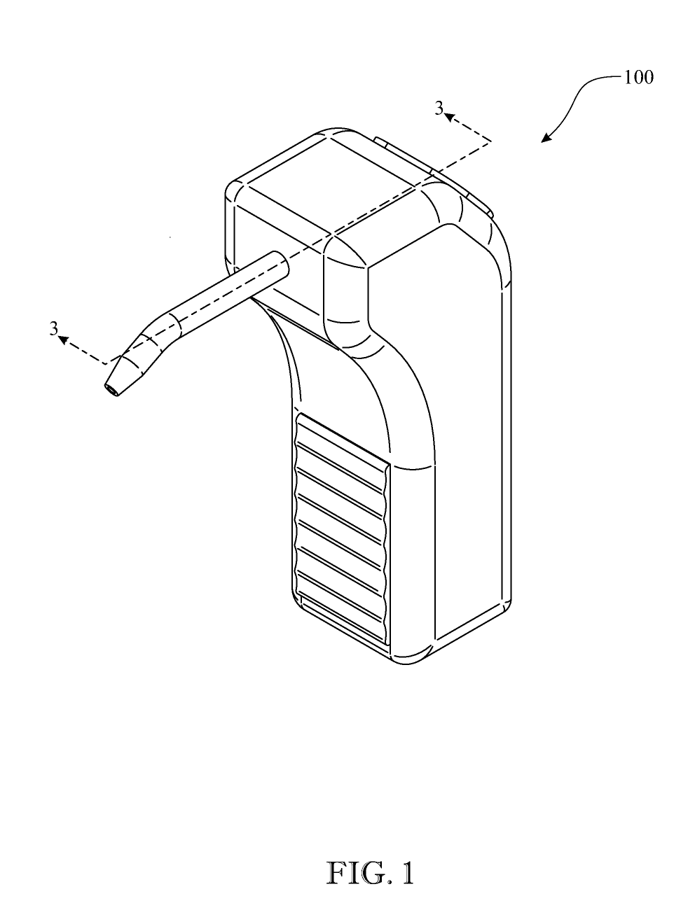

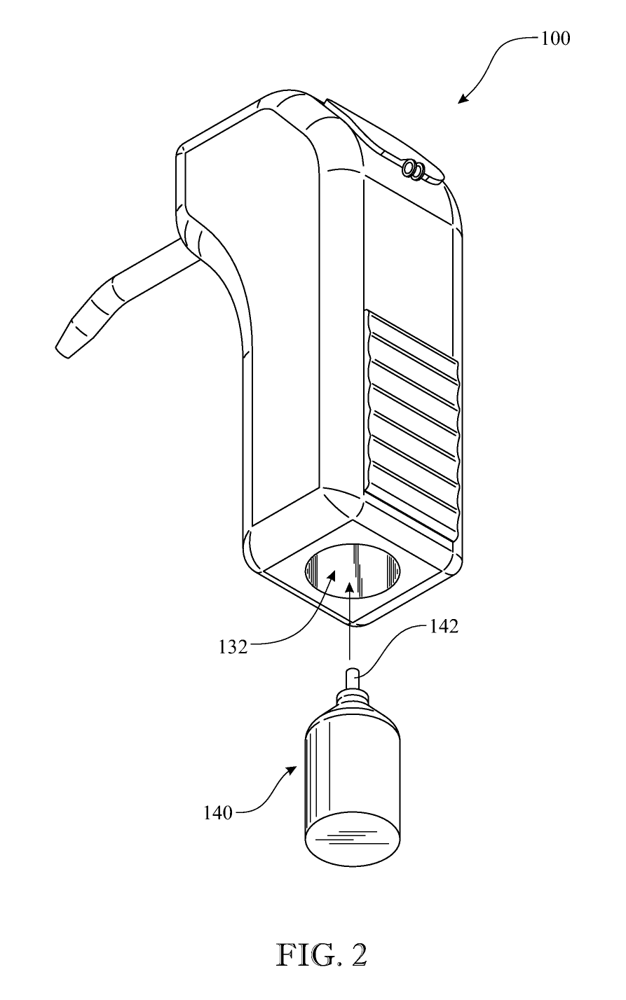

A portable handheld pressurized dental cleaning apparatus or appliance 100 (hereinafter for the sake of brevity being referred to as the “dental appliance”) is presented in various views in the illustrations of FIGS. 1 through 3, according to a first exemplary implementation of the invention. The dental appliance 100 forms a kit with a removable and disposable pressurized air cartridge 140 that can be installed in dental appliance 100. The appliance 100 includes a housing body 110 having an upper end 112 and a lower end 114. The housing body 110 has an outer/rear/back side 116, and an inner/front side 118, and a lower/bottom side 119. The housing body 110 is configured as a hand-held unit defining an enclosed, interior cavity 120 and with a handgrip formed the lower end 114 to assist in using the dental appliance 100.

The housing body 110 includes a main section/portion 122 and a head section/portion 124. The head section 124 projects forward of the main section 122 in the direction from the outer side 116 to the inner side 118 to facilitate working access of the dental appliance 100 to a targeted dental site. The interior cavity 120 of housing body 110 includes a lower compartment 130 adapted to receive and releasably hold a disposable cartridge, or canister, 140 of pressurized air, such as a CO₂ cartridge. The cartridge 140 has a conventional construction including a movable control rod 142 that acts as a valve to regulate release of the pressurized air contents. The interior cavity 120 of the housing body 110 further includes an upper compartment 135 configured to contain a volume of an abrasive cleaning composition 152. The upper compartment 135 may have a container in the form of an interior capsule 150 being fixedly and permanently located within the interior cavity 120 of the housing body 110. The capsule 150 is configured as a reservoir to house and dispense the cleaning composition 152 originally stored, for instance, in the form of dry powder contents in capsule 150.

The lower compartment 130 is configured to have a geometry that is complementary to the pressurized air cartridge 140 in order to facilitate installation and housing of cartridge 140 in dental appliance 100. The lower side 119 of dental appliance 100 includes an entry/insertion opening 132 defined at a bottom end of the lower compartment 130 through which the cartridge 140 is inserted and then maneuvered into place in lower compartment 130. In one exemplary form, the lower compartment 130 includes a body section 134 and a reduced or tapered neck section 136 that terminates in a port or opening 138. During installation of cartridge 140, a control rod 142 of cartridge 140 is extended through the opening 138 formed in the neck section 136 of lower compartment 130 and placed into a position for actuation of the control rod 142 to provide fluid communication of pressurized air from the cartridge 140 to the capsule 150 in the upper compartment 135 of the interior cavity 120 of the housing body 110.

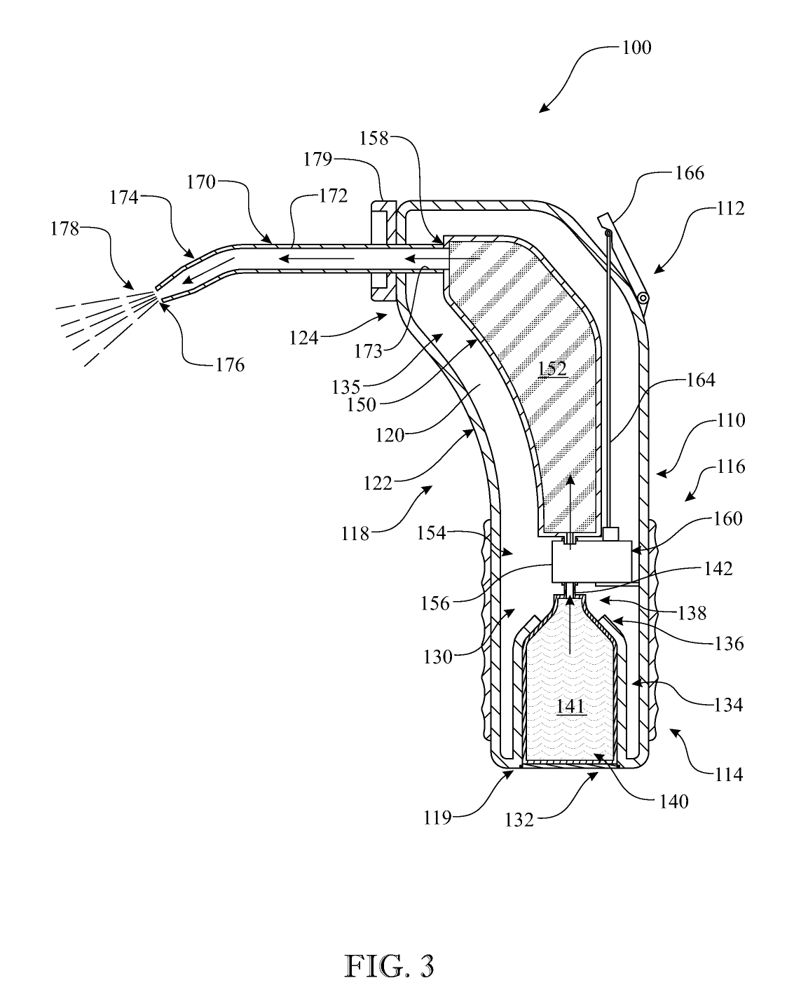

The dental appliance 100 further includes an actuator mechanism, generally designated 160, to selectively operate and control the activation of the control rod 142 of the installed cartridge 140 and so regulate and enable the release of pressurized air contents 141 from the cartridge 140 and into the capsule 150 via the actuator mechanism 160. The capsule 150 includes a lower end 154 that defines an air input opening. The actuator mechanism 160 extends between and is vertically aligned with the opening 138 of neck section 136 of lower compartment 130 and the lower end 154 of the capsule 150. In this manner, when cartridge 140 is installed in lower compartment 130, the actuator mechanism 160 upon actuation will activate the control rod 142 of cartridge 140 to release pressurized air from the cartridge 140 in a controlled flow and communicated it to the cleaning composition contents 152 in capsule 150 so as to facilitate discharge from capsule 150. The capsule 150 also includes a discharge opening or output port 158 through which the cleaning composition contents 152 in the capsule 150 are dispensed or discharged when subjected to the pressurized air released from cartridge 140. By way of example but not limitation, the actuator mechanism 160 may include a release valve and a pressure regulator (not being shown in FIG. 3) both selectively actuatable at the exterior location on the housing body 110. The pressure regulator may be a check valve.

The actuator mechanism 160 includes a pivoting control lever (not shown) adapted to engage the control rod 142 of cartridge 140 to selectively control the activation of the installed cartridge 140 and so regulate the release of pressurized air contents 141 into the capsule 150. The actuator mechanism 160 also includes an actuator arm 164 adapted to activate (pivot) the control lever, and an external button 166, accessible by a user, that is connected to actuator arm 164. The user can depress button 166 to move the actuator arm 164 in the downward direction shown to pivot the control lever and so displace the control rod 142 of cartridge 140 in a manner sufficient to release a desired portion of the pressurized air 141. It should be apparent to those skilled in the art that any suitable type of actuator mechanism 160 can be employed to perform these operations.

The dental appliance 100 further includes a removable elongated hollow nozzle assembly 170 disposed at the upper end 112 of dental appliance 100 in head section 124 at inner side 118. The hollow nozzle assembly 170 includes a conveyance member in the form of an open-ended elongated hollow tubular nozzle conduit 172 that is disposed in fluid communication with the cleaning composition discharge port 158 of interior capsule 150. In this manner, any cleaning composition contents 152 discharged from the capsule 150 will enter an inlet aperture 173 at a proximal end of the conduit 172 located within the upper compartment 135 and travel through the elongated hollow tubular nozzle conduit 172. The hollow nozzle assembly 170 further includes a tip section 174 having a terminal output port or outlet aperture 176 at a distal end of the nozzle conduit 172 terminating outside the housing body 110 through which any powder contents 152 communicated through nozzle conduit 172 will emerge and be directed or delivered to the dental site as an emission stream 178. In one exemplary form, the tip section 174 has an angular orientation relative to the longitudinal axis of the nozzle conduit 172 in order to facilitate better access and delivery of the emission stream 178 to the dental site. However, it should be apparent to those skilled in the art that any type of hollow nozzle assembly 170, including any configuration of tip section 174, can be implemented.

The combination of dental appliance 100 and air cartridge 140 can be packaged as an installation-ready kit. During use, following installation of cartridge 140, the dental appliance 100 can be operated to deliver the energized powder contents as a pressurized emission stream 178 to a dental site such as a set of teeth. The dental appliance 100 can be used to polish and clean teeth with the emission stream 178. Once the air contents of cartridge 140 are exhausted, the empty cartridge 140 can be removed and replaced with a new one. This will be done especially if powder contents 152 still remain in capsule 150. Alternatively, as will be apparent to those skilled in the art, it is possible that remaining powder contents could be utilized in a subsequent operation (i.e., rather than removing and discarding such left over powder contents). Once the powder contents 152 are fully depleted, the dental appliance 100 is preferably discarded, particularly in an implementation of the invention wherein the capsule 150 is intended for a single-use powder application, i.e., where capsule 150 cannot be replenished. However, it will be appreciated by those skilled in the art that it is well within the scope of the invention to incorporate a more permanent, or multiple use, capsule 150. The dental appliance 100 of this exemplary implementation, as well as the dental appliances 200, 300, 400 of the other exemplary implementations to be described hereinafter, may also have a light source 179, such as an LED light source, mounted to the exterior of the head section 124 and surrounding the nozzle conduit 172 of the hollow nozzle assembly 170. The light source 179 may be configured to direct light toward and past the nozzle tip section 174 so as to illuminate the dental site. As will be apparent to those skilled in the art, a light source 179 can be integrated anywhere upon or within the appliance, as long as adequate light is directed toward the distal end of the nozzle assembly 170.

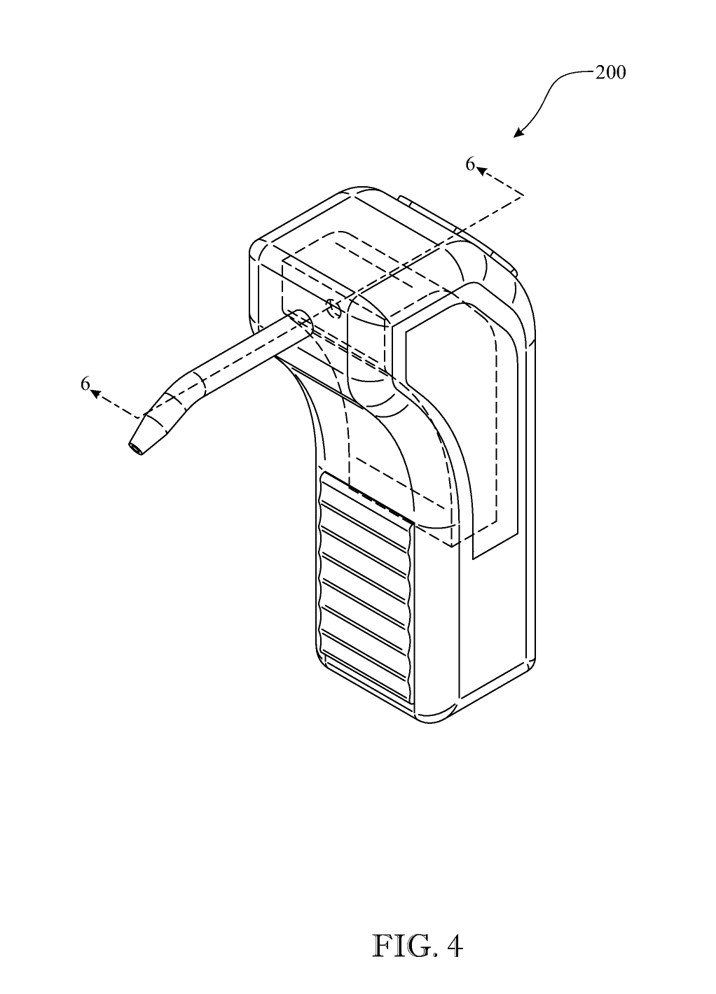

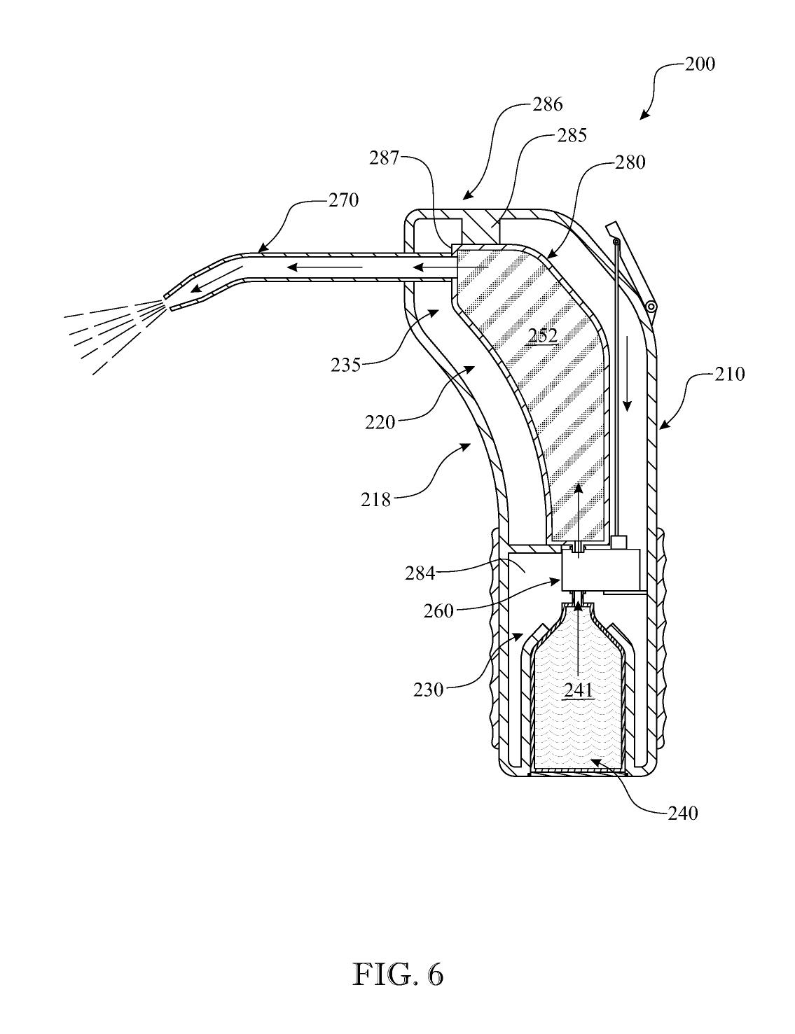

A dental appliance 200 is presented in the illustrations of FIGS. 4 through 6, according to a second exemplary implementation of the invention. The dental appliance 200 forms a kit with a combination including a removable and disposable container in the form of a canister 280, containing a cleaning composition, and a removable and disposable pressurized air cartridge 240. Both the cleaning composition canister 280 and the air cartridge 240 can be separately installed in dental appliance 200. Like features of the dental appliance 200 and dental appliance 100 (FIGS. 1 through 3), some of which will not described in detail hereinafter, are numbered the same except preceded by the numeral ‘2’.

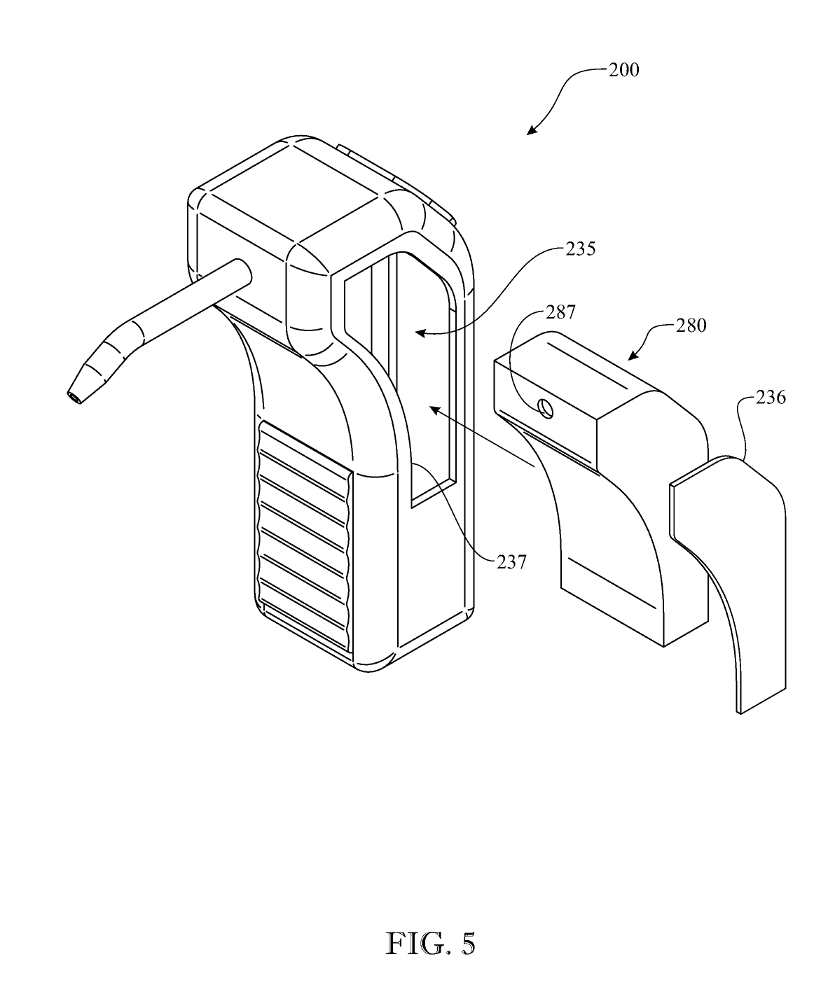

The dental appliance 200 includes a housing body 210 defining an interior housing space or cavity 220. The interior cavity 220 includes an upper compartment 235 configured to receive and hold the replaceable cleaning composition canister 280 containing or storing, for example powder 252. As shown in FIG. 5, the cleaning composition canister 280 can be installed in dental appliance 200 by detaching a removable cover 236 and inserting it into upper compartment 235 through a side opening 237 in the housing body 210 and then re-attaching the cover 236 to close the side opening 237. In order to facilitate the definition and configuration of the upper compartment 235, the housing body 210 is configured with a laterally projecting lower member in the form of a flange or cantilever platform 284 that extends into the interior cavity 220 from the inner side 218 of the housing body 210. The cantilever platform 284 defines the lowermost level of the upper compartment 235 and acts as an abutment that fixes the lower location of cleaning composition canister 280 during installation. The housing body 210 is also configured with a longitudinally projecting upper member in the form of a flange 285 that extends into the interior cavity 220 from an upper side 286 of housing body 210. The longitudinal flange 285 defines the uppermost level of the upper compartment 235 and acts as an abutment that fixes the upper location of cleaning composition canister 280 during installation. Thus, the cleaning composition canister 280 is received within the upper compartment 235 such that at its bottom it is located and rests upon the cantilever platform 284 and at its top or upper side it underlies and engages an axial face of longitudinal flange 285.

The cleaning composition canister 280 has an appropriate opening or discharge port 287 that automatically fits, and is thereby disposed in fluid communication, with the hollow nozzle assembly 270 following installation of cleaning composition canister 280 in dental appliance 200. The discharge portion 287 of the canister 280 permits communication of its cleaning composition contents 252 into hollow nozzle assembly 270. It should be apparent to those skilled in the art that the alignment and registration of the various input and output ports and openings can be determined in a conventional manner.

During use of the dental appliance 200, the cleaning composition canister 280 will be installed and present in the upper compartment 235 of dental appliance 200. Likewise, the air cartridge 240 will be installed and present in the lower compartment 230. The dental appliance 200 then operates in a manner similar to dental appliance 100. However, the dental appliance 200 is not a single-use applicator but is a reusable unit since both the cleaning composition contents and pressurized air can be replenished. In particular, a new cleaning composition canister 280 can be installed once the contents of the old one are depleted. Likewise, a new air cartridge 240 can be installed once the contents of the old one are depleted.

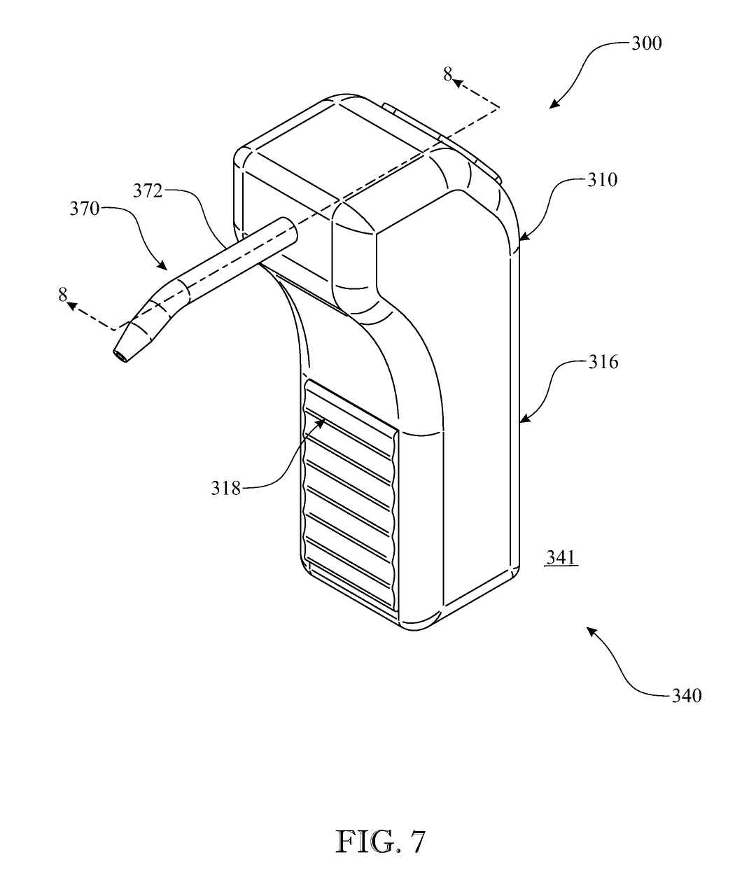

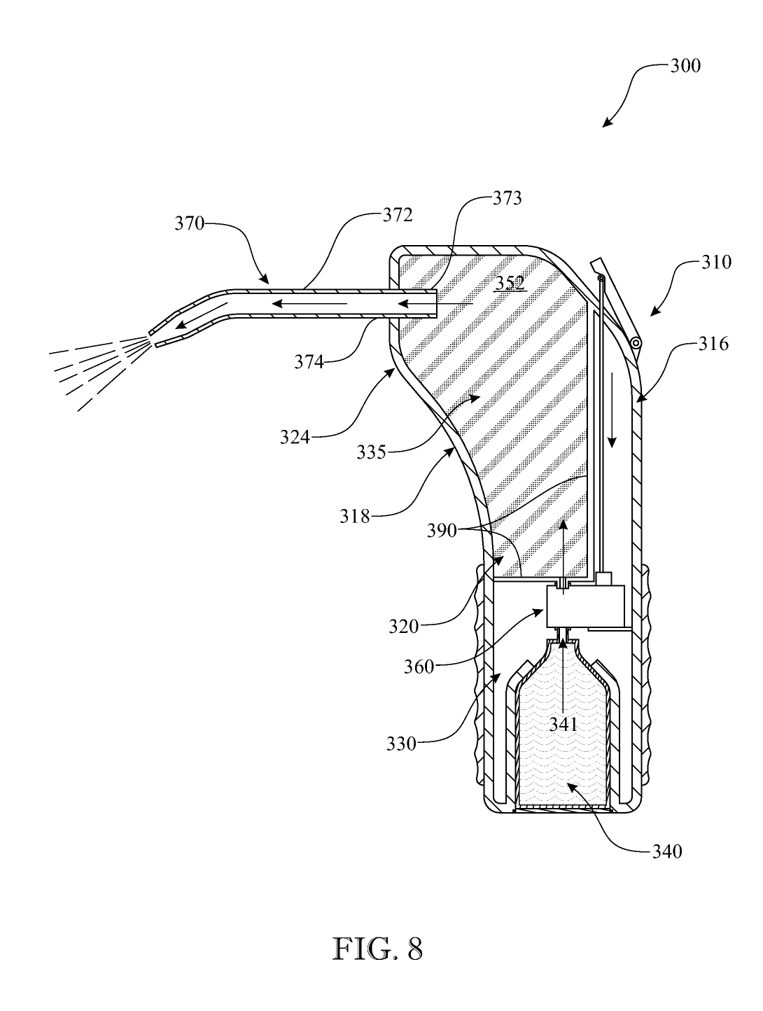

A dental appliance 300 is presented in FIGS. 7 and 8, according to a third exemplary implementation of the invention. The dental appliance 300 forms a kit with a removable and disposable pressurized air cartridge 340 that can be installed in dental appliance 300. Like features of the dental appliance 300 and dental appliances 100 (FIGS. 1 through 3) and 200 (FIGS. 4 through 6), some of which will not described hereinafter, are numbered the same except preceded by the numeral ‘3’.

The dental appliance 300 includes a housing body 310 defining an interior housing space or cavity 320. The dental appliance 300 further includes an angled partition wall 390 extending fully between the inner side 318 and outer side 316 of housing body 310. The partition wall 390 segments or divides the interior cavity 320 into an upper compartment 335 and a lower 330. The lower compartment 330 is configured to receive air cartridge 340.

The upper compartment 335 of the interior cavity 320 of the housing body 310 defines a reservoir that is loaded with cleaning composition contents 352. By comparison, the cleaning composition contents of dental appliance 100 (FIGS. 1 through 3) are furnished by a permanently installed interior capsule 150; while the cleaning composition contents of dental appliance 200 (FIGS. 4 through 6) are furnished by a removable canister 280. The dental appliance 300 also includes a hollow nozzle assembly 370, like that of the earlier exemplary implementations, having an elongated hollow tubular nozzle conduit 372 having an open-ended input port 373 fitted through an aperture 374 on the head section 324 of the housing body 310 so as to dispose the hollow nozzle assembly 370 in fluid communication with the reservoir of the upper compartment 335 of housing cavity 320. In this manner, the energized cleaning composition contents 352 can enter directly into hollow nozzle assembly 370 via its input port 373.

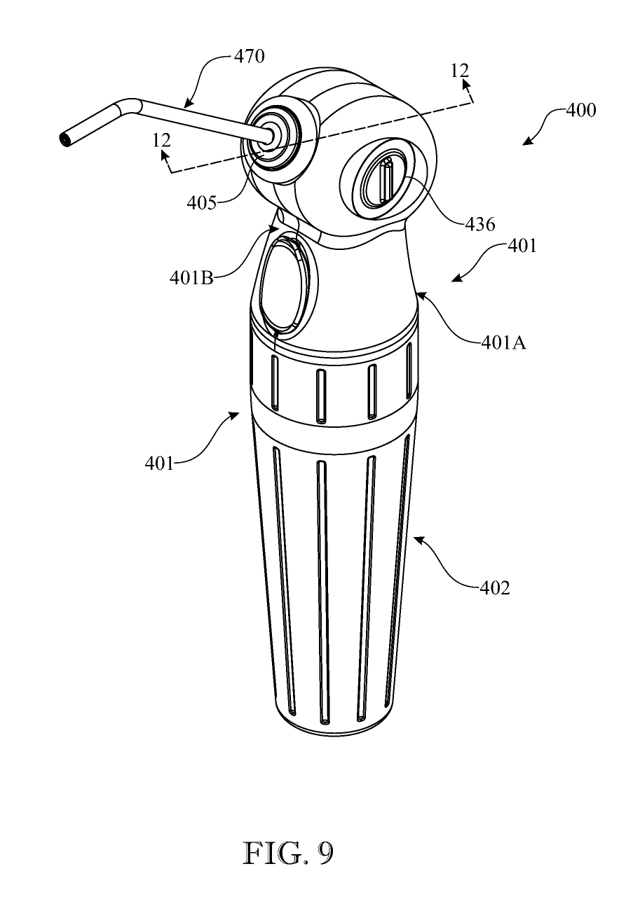

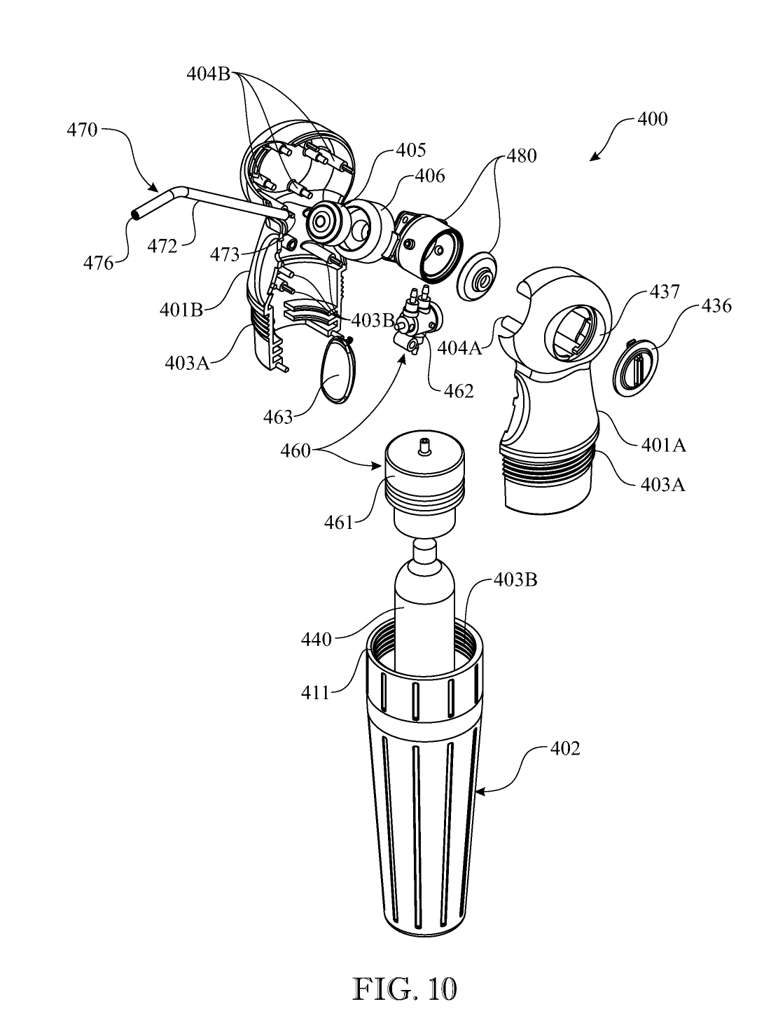

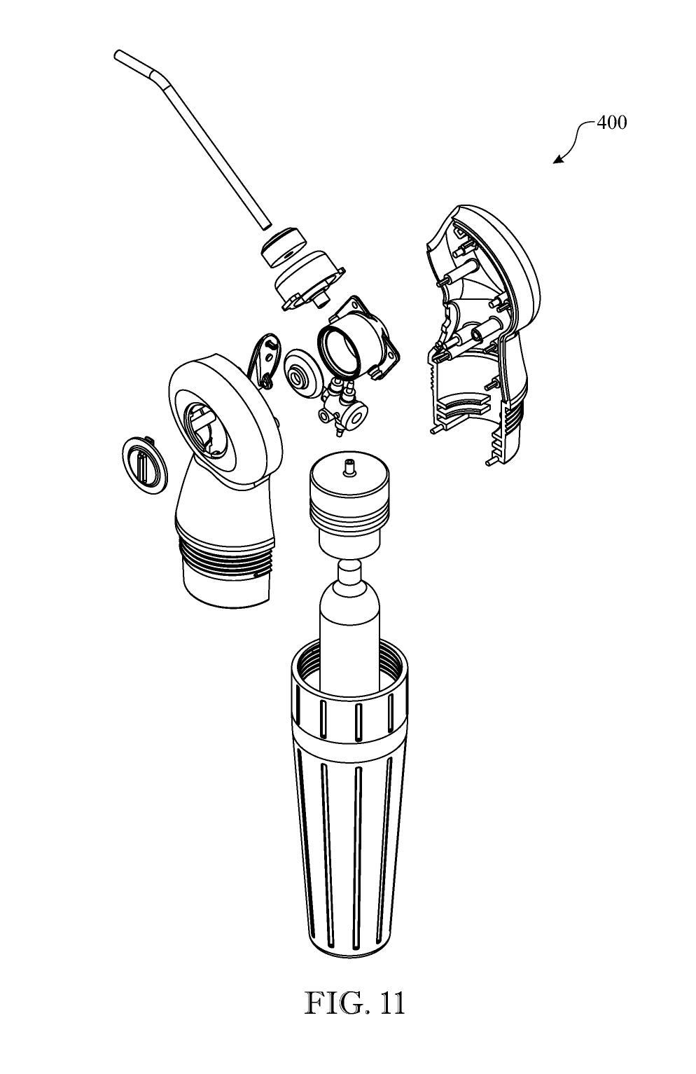

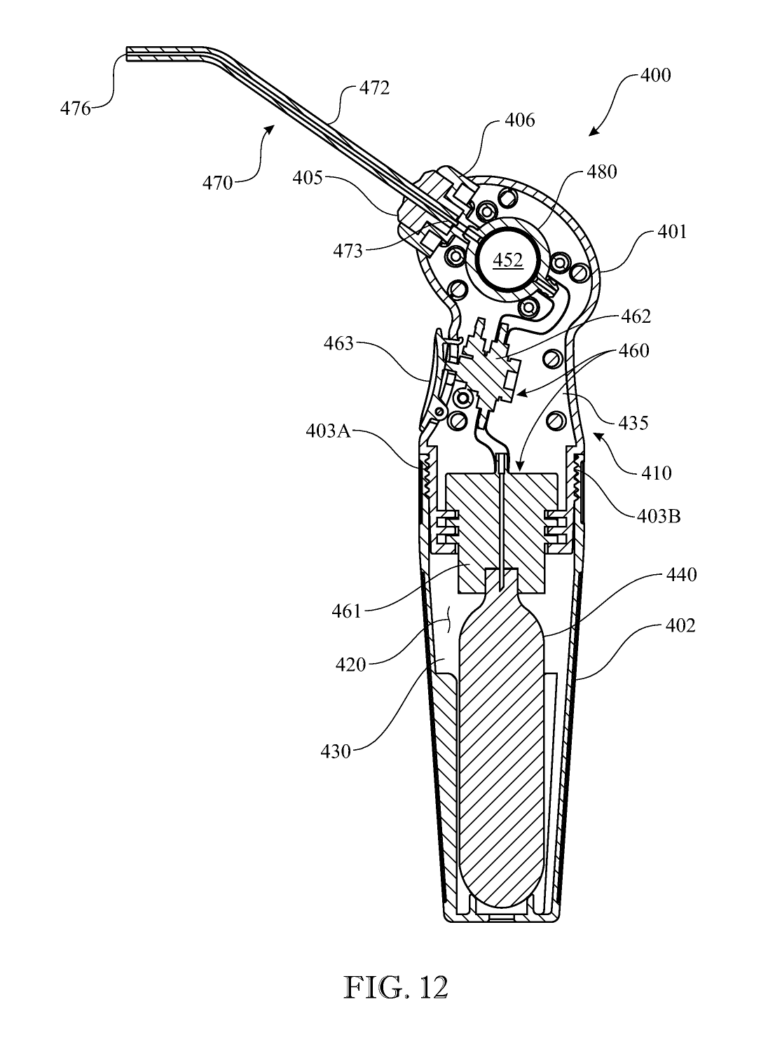

A dental appliance 400 is presented in the illustrations of FIGS. 9 through 12, according to a fourth exemplary implementation of the invention. The dental appliance 400 forms a kit with a combination including a removable and disposable container in the form of a cleaning composition canister 480 and a removable and disposable pressurized air cartridge 440. Both the cleaning composition canister 480 and the air cartridge 440 can be separately installed in dental appliance 400. Like features of the dental appliance 400 and dental appliances 100 (FIGS. 1 through 3), 200 (FIGS. 4 through 6) and 300 (FIGS. 7 and 8) are numbered the same except preceded by the numeral ‘4’.

The dental appliance 400 includes a housing body 410 having an upper shell portion 401 and a lower receptacle portion 402 detachably attached to the upper shell portion 401 by complementary sets of external screw threads 403A extending about the exterior of the lower end of the upper shell portion and internal screw threads 403B extending about the interior of the upper end of the lower receptacle. When the upper shell portion 401 and lower receptacle portion 402 are screwed together they define an interior cavity 420 such that the upper shell portion 401 defines an upper compartment 435 of the housing body 410 and the lower receptacle portion 402 defines a lower compartment 430 of the housing body 410. The lower receptacle portion 402 at its exterior is formed as a handle or handgrip to assist in using the dental appliance 400.

The dental appliance 400 also includes an elongated hollow nozzle assembly 470 mounted to the upper shell portion 401 of the housing body 410. The hollow nozzle assembly 470 has an elongated hollow nozzle conduit 472 being held by a nozzle holder 405, in turn, supported by a nozzle holder support ring 406. The nozzle conduit 472 extends between an inlet aperture 473 at an proximal end of the hollow nozzle assembly 470 and an outlet aperture 476 at a distal end of the hollow nozzle assembly such that the proximal end inlet aperture 473 is disposed in fluid communication with the upper compartment 435 of the housing body 410. The distal end outlet aperture 476 of the hollow nozzle assembly 470 is disposed outside of the housing body 410.

The dental appliance 400 further includes a cleaning composition containment container 480 disposed within the upper compartment 435 in the upper shell portion 401 of the housing body 410, a self-contained pressurized air cartridge 440 provided in the lower compartment 430 in the lower receptacle portion 402 of the housing body 410, and an actuator mechanism 460 connecting the pressurized air cartridge 440 disposed in the lower compartment 430 in fluid communication with the cleaning composition container 480 disposed in the upper compartment 435. The container 480 is configured for holding a volume of cleaning composition. The proximal end inlet aperture 473 of the hollow nozzle assembly 470 is disposed in fluid communication with the volume of cleaning composition 452 in the container 480. The actuator mechanism 460 includes a pressure regulator 461 and a release valve 462. The pressure regulator 461 is supported at and extends below a lower end of the upper shell portion 401. The release valve 462 is supported by the upper shell portion 401 between the pressure regulator 461 and the cleaning composition container 480 such that the release valve 462 is connected in fluid communication with the pressure regulator 461 and the cleaning composition container 480 and is selectively activated by operating a lever 463 mounted at an exterior location on the housing body 410 on the upper shell portion 401 to controllably actuate and enable fluid communication of pressurized air from the pressurized air cartridge 440 in the lower compartment 430 to the volume of cleaning composition in the container 480 in the upper compartment 435 so as to thereby cause pressurized flow of portions of the cleaning composition 452 into the proximal end inlet aperture 473 of the hollow nozzle assembly 470 and from the distal end outlet aperture 476 of the hollow nozzle assembly 470. It is contemplated that the nozzle may be constructed as a replaceable disposable component or as a permanent/reusable component.

More particularly, the upper shell portion 401 of the housing body 410 comprises left and right sections 401A, 401B with complementary sets of protruding mateable rods 404A, 404B thereon that press into and fixedly connect with one another so as to securely fit the left and right sections 401A, 401B together and thereby form the upper shell portion 401 and enclose and support the hollow nozzle assembly 470 at the proximal end thereof, the nozzle holder support ring 406, the cleaning composition container 480, and the pressure regulator 461 and release valve 462 of the actuator mechanism 460. The upper shell portion 401 of the housing body 410 has a removable cover 436 detachably attached over a side opening 437 in the upper shell portion 401 of the housing body 410 for gaining access to the upper compartment 435 of the housing body 410. The cleaning composition container 480 is insertable into and removable from the upper compartment 435 through the side opening 437 in the housing body 410. The lower receptacle portion 402 of the housing body 410 has a top opening 411 in an upper end of the lower receptacle portion 402 for gaining access to the lower compartment 430 of the housing body 410. The pressurized air cartridge 440 is insertable into and removable from the lower compartment 430 through the top opening 411 in the upper end of the lower receptacle portion 402 of the housing body 410.

In the various exemplary implementations, a variety of options are available in the selection of powders. The powders can be a blend of ingredients having various sizes and flavors. For example, the particle size can vary from 14-65 microns, although other sizes are possible. A selection of flavors can include mint, cinnamon, ginger lemongrass, and bubble gum, although other flavors are possible. Furthermore, any type of antibacterial agent, including natural botanical herbs and extracts, can be incorporated into the abrasive powder or added as a separate component. In a typical formulation, the powder will include sodium bicarbonate and/or calcium carbonate as a base, although other compositions are possible. The powder can also be formulated with different levels of abrasiveness. Also, it should be understood that in the various exemplary implementation, the form of the cleaning composition need not to be a dry powder. Alternatively, it could be particles suspended in a fluid (possibly as a colloidal suspension), a liquid, or a solid tablet that breaks apart easily in response to impingement by the pressurized air. Further, a variety of geometries can be employed for the hollow nozzle, particularly the tip section, used in the various exemplary implementations. Also, the housing body is preferably constructed using environmentally-friendly materials. Further, the appliance may have a user-friendly design that makes it adaptable for home usage by anyone; not just a dental professional in a dental office environment. Also, the device can be used on animal teeth, not just human teeth and appliances.

The dental appliance 100 of FIGS. 1 through 3 and the dental appliance 300 of FIGS. 7 and 8 can be provided as a kit in the form of a hand-held unit including a permanently installed powder capsule and a disposable tip, and accompanied in the packaging with an installation-ready CO₂ cartridge and a wire for de-clogging the unit. The dental appliance 200 of FIGS. 4 through 6 and the dental appliance 400 of FIGS. 9 through 12 can be provided as a kit in the form of a hand-held unit including an installation-ready CO₂ cartridge and an installation-ready powder canister, both removable and disposable components.

An advantage of these dental appliances is that they operate as self-sufficient, stand-alone units. There is no requirement for external hook-ups to an exterior power source, such as a tank of pressurized air. Instead, according to the invention, the various dental appliances are self-powering via utilization of the pressurized air cartridges installed in the hand-held units. Additionally, there is no need for an external hook-up to a source of cleaning solution (powder). Instead, the cleaning powder is stored in the dental appliances in various ways, for example, as in a permanently installed capsule (FIGS. 1 through 3); or in a removable and disposable canister (FIGS. 4 through 6, and FIGS. 9 through 12); or loaded within a dedicated zone formed by a partitioning of the interior cavity (FIGS. 7 and 8).

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. A portable handheld pressurized dental cleaning apparatus, comprising:
a housing body defining an interior cavity having an upper compartment and a lower compartment;
an elongated hollow nozzle assembly mounted to said housing body and having a proximal end and a distal end, said proximal end being disposed in fluid communication with said upper compartment of said housing body interior cavity, said distal end terminating outside of said housing body;
a volume of cleaning composition contained within said upper compartment of said housing body interior cavity, said proximal end of said hollow nozzle assembly being in fluid communication with said cleaning composition;
a self-contained pressurized air cartridge disposed within said lower compartment of said housing body interior cavity; and
an actuator mechanism connecting said pressurized air cartridge in said lower compartment of said housing body interior cavity to said cleaning composition in said upper compartment of said housing body interior cavity, said actuator mechanism being selectively activated at an exterior location on said housing body to controllably actuate and enable fluid communication of pressurized air from said pressurized air cartridge to said volume of cleaning composition in said upper compartment of said housing body interior cavity so as to thereby cause pressurized flow of portions of said cleaning composition into said proximal end of said hollow nozzle assembly and from said distal end of said hollow nozzle assembly.

2. The apparatus as recited in claim 1 wherein said hollow nozzle assembly has an elongated hollow nozzle conduit extending between an inlet aperture at said proximal end and an outlet aperture at said distal end, said proximal end inlet aperture being contained within said upper compartment of said housing body interior cavity in fluid communication with said volume of cleaning composition, said distal end outlet aperture being disposed outside of said housing body.

3. The apparatus as recited in claim 1 further comprising a reservoir disposed within said upper compartment of said housing body interior cavity and being configured for holding said volume of cleaning composition, said proximal end of said hollow nozzle assembly being in fluid communication with said reservoir.

4. The apparatus as recited in claim 3 wherein said housing body has an angled partition wall divides said interior cavity into said lower compartment and said reservoir of said upper compartment.

5. The apparatus as recited in claim 1 further comprising a capsule fixedly and permanently disposed within said upper compartment of said housing interior cavity and being configured for holding said volume of cleaning composition, said proximal end of said hollow nozzle assembly being in fluid communication with said cleaning composition in said capsule.

6. The apparatus as recited in claim 1 further comprising a canister removably disposed within said upper compartment of said housing interior cavity and being configured for holding said volume of cleaning composition, said proximal end of said hollow nozzle assembly being in fluid communication with said cleaning composition in said canister.

7. The apparatus as recited in claim 6 wherein said housing body has a removable cover detachably attached over a side opening in said housing body for gaining access to said upper compartment of said housing body interior cavity, said canister being insertable into and removable from said upper compartment through said side opening in said housing body.

8. The apparatus as recited in claim 1 wherein said housing body has a bottom opening in a lower end of said housing body for gaining access to said lower compartment of said housing body interior cavity, said pressurized air cartridge being insertable into and removable from said lower compartment through said bottom opening in said lower end of said housing body.

9. The apparatus as recited in claim 1 wherein said actuator mechanism includes a release valve and a pressure regulator both selectively actuatable at said exterior location on said housing body.

10. The apparatus as recited in claim 9 wherein said housing body comprises an upper shell portion and a lower receptacle portion detachably attached to said upper shell portion, said upper shell portion defining said upper compartment and being configured to support said cleaning container canister, said hollow nozzle assembly and said pressure regulator and release valve of said actuator mechanism, said lower handle portion defining said lower compartment and being configured to support said pressurized air cartridge.

11. A portable handheld pressurized dental cleaning apparatus, comprising:
a housing body defining an interior cavity having an upper compartment and a lower compartment;
an elongated hollow nozzle assembly mounted to said housing body and having a proximal end and a distal end, said hollow nozzle assembly having an elongated hollow nozzle conduit extending between an inlet aperture at said proximal end of said hollow nozzle assembly and an outlet aperture at said distal end of said hollow nozzle assembly, said proximal end inlet aperture being disposed in fluid communication with said upper compartment of said housing body interior cavity, said distal end outlet aperture being disposed outside of said housing body;
a container disposed within said upper compartment of said housing body interior cavity and being configured for holding a volume of cleaning composition, the proximal end inlet aperture of said hollow nozzle assembly being in fluid communication with said volume of cleaning composition in said container;
a self-contained pressurized air cartridge provided within said lower compartment of said housing body interior cavity; and
an actuator mechanism connecting said pressurized air cartridge in said lower compartment of said housing body interior cavity to said container in said upper compartment of said housing body interior cavity, said actuator mechanism being selectively activated at an exterior location on said housing body to controllably actuate and enable fluid communication of pressurized air from said pressurized air cartridge in said lower compartment to said volume of cleaning composition in said container in said upper compartment so as to thereby cause pressurized flow of portions of said cleaning composition into said proximal end inlet aperture of said hollow nozzle assembly and from said distal end outlet aperture of said hollow nozzle assembly.

12. The apparatus as recited in claim 11 wherein said container is a capsule fixedly and permanently disposed within said upper compartment of said housing interior cavity and being configured for holding said volume of cleaning composition, said proximal end inlet aperture of said hollow nozzle assembly being disposed in fluid communication with said cleaning composition in said capsule.

13. The apparatus as recited in claim 11 wherein said container is a canister removably disposed within said upper compartment of said housing interior cavity and being configured for holding said volume of cleaning composition, said proximal end inlet aperture of said hollow nozzle assembly conduit being disposed in fluid communication with said cleaning composition in said canister.

14. The apparatus as recited in claim 13 wherein said housing body has a removable cover detachably attached over a side opening in said housing body for gaining access to said upper compartment of said housing interior cavity, said canister being insertable into and removable from said upper compartment through said side opening in said housing body.

15. The apparatus as recited in claim 11 wherein said housing body has a bottom opening in a lower end of said housing body for gaining access to said lower compartment of said housing interior cavity, said pressurized air cartridge being insertable into and removable from said lower compartment through said bottom opening in said lower end of said housing body.

16. The apparatus as recited in claim 11 wherein said actuator mechanism includes a release valve and a pressure regulator both selectively actuatable at said exterior location on said housing body.

17. A portable handheld pressurized dental cleaning apparatus, comprising:
a housing body having an upper shell portion and a lower receptacle portion detachably attached to said upper shell portion and together defining an interior cavity, said upper shell portion defining an upper compartment of said housing body interior cavity, said lower receptacle portion defining a lower compartment of said housing body interior cavity;
an elongated hollow nozzle assembly mounted to said upper shell portion of said housing body and having a proximal end and a distal end, said hollow nozzle assembly having an elongated hollow nozzle conduit extending between an inlet aperture at said proximal end of said hollow nozzle assembly and an outlet aperture at said distal end of said hollow nozzle assembly, said proximal end inlet aperture of said hollow nozzle assembly being disposed in fluid communication with said upper compartment of said housing body interior cavity, said distal end outlet aperture of said hollow nozzle assembly being disposed outside of said housing body;
a container disposed within said upper compartment in said upper shell portion of said housing body and being configured for holding a volume of cleaning composition, said proximal end inlet aperture of said hollow nozzle assembly being in fluid communication with said volume of cleaning composition in said container;
a self-contained pressurized air cartridge provided within said lower compartment in said lower receptacle portion of said housing body; and
an actuator mechanism connecting said pressurized air cartridge in said lower compartment to said cleaning composition container in said upper compartment, said actuator mechanism including a pressure regulator and a release valve, said pressure regulator supported at and extending below a lower end of said upper shell portion and in fluid communication with the pressurized air cartridge, said release valve being supported by said upper shell portion between said pressure regulator and said container such that said release valve is connected in fluid communication with said pressure regulator and said container and is selectively activated at an exterior location on said housing body adjacent to said upper shell portion to controllably actuate and enable fluid communication of pressurized air from said pressurized air cartridge in said lower compartment to said volume of cleaning composition in said cleaning composition container in said upper compartment so as to thereby cause pressurized flow of portions of said cleaning composition into said proximal end inlet aperture of said hollow nozzle assembly and from said distal end outlet aperture of said hollow nozzle assembly.

18. The apparatus as recited in claim 17 wherein said upper shell portion comprises left and right sections with sets of complementary protrusions thereon being connectable with one another so as to securely fit said left and right sections together and thereby form said upper shell portion and enclose and support said hollow nozzle assembly at said proximal end thereof, said cleaning composition container, and said pressure regulator and said release valve of said actuator mechanism.

19. The apparatus as recited in claim 17 wherein said upper shell portion of said housing body has a removable cover detachably attached over a side opening in said upper shell portion of said housing body for gaining access to said upper compartment of said housing body, said cleaning composition container being insertable into and removable from said upper compartment through said side opening in said housing body.

20. The apparatus as recited in claim 17 wherein said lower receptacle portion of said housing body has a top opening in an upper end of said lower receptacle portion for gaining access to said lower compartment of said housing body, said pressurized air cartridge being insertable into and removable from said lower compartment through said top opening in said upper end of said lower receptacle portion of said housing body.
